(19) United States
(12) Patent Application Publication
(10) Pub. No.: US 2017/0032451 A1
(43) Pub. Date: Feb. 2, 2017

(54) ORDER RECEPTION APPARATUS AND MANAGEMENT APPARATUS

(71) Applicant: TOSHIBA TEC KABUSHIKI KAISHA, Tokyo (JP)

(72) Inventor: Takahiro Nakamura, Kannami Tagata Shizuoka (JP)

(21) Appl. No.: 15/220,533

(22) Filed: Jul. 27, 2016

(30) Foreign Application Priority Data
Jul. 29, 2015 (JP) 2015-150159

(51) Int. Cl. G06Q 30/06; G06Q 20/20; G06F 3/0482

(52) U.S. Cl. CPC G06Q 30/0635; G06F 3/0482; G06Q 20/20

(57) ABSTRACT

An order reception apparatus comprises an operation device configured to receive an image display and an operation input; an order reception module configured to receive an order information relating to an order via the operation device; an extraction module configured to extract a history of the operation input and the image display in the operation device as a use status information; and a notification module configured to regularly notify a management apparatus of the use status information.

### CROSS-REFERENCE TO RELATED APPLICATION

This application is based upon and claims the benefit of priority from Japanese Patent Application No. 2015-150159, filed Jul. 29, 2015, the entire contents of which are incorporated herein by reference.

### FIELD

Embodiments described herein relate generally to an order reception apparatus and a management apparatus.

### BACKGROUND

Conventionally, a self-ordering system through which a customer inputs order information by himself/herself is introduced in a restaurant such as a tavern or a pub. In the self-ordering system, an order reception apparatus that is handed over to a customer to be used wirelessly sends the order information (containing a table code, a menu code and the like) to an order station. The order station executes an order reception processing based on the order information sent from the order reception apparatus. Further, the order reception apparatus displays images of commodities as a menu and a list of commodities which are ordered.

However, in a case of introducing the self-ordering system described above, there is a case in which the customer does not understand how to use the order reception apparatus and thus no screen operation is executed even if a certain period elapses after the customer enters the restaurant.

Regarding this point, although a technology capable of providing proper service in response to an operation status of an order terminal is disclosed, an extraction target as a use status is restricted to an operation input.

### DESCRIPTION OF THE DRAWINGS

FIG. 1 is a system configuration diagram schematically illustrating the whole configuration of an order entry system according to an embodiment;

FIG. 2 is a block diagram illustrating the electrical connection of an order reception apparatus and a management terminal;

FIG. 3 is a flowchart illustrating an example of the flow of an order reception processing by the order reception apparatus;

FIG. 4 is a front view exemplifying a screen display in the order reception processing on an LCD of the order reception apparatus;

FIG. 5 is a block diagram illustrating the electrical connection of an order station;

FIG. 6 is a schematic view illustrating an example of the data structure of an order file stored in the order station;

FIG. 7 is a block diagram illustrating functions relating to a use status notification processing;

FIG. 8 is a flowchart illustrating an example of the flow of the use status notification processing;

FIG. 9 is a block diagram illustrating functions relating to an alert notification processing; and

FIG. 10 is a flowchart illustrating an example of the flow of the alert notification processing.

### DETAILED DESCRIPTION

An order reception apparatus according to an embodiment comprises an operation device configured to receive an image display and an operation input, an order reception module configured to receive an order information relating to an order via the operation device, an extraction module configured to extract a history of the operation input and the image display in the operation device as an use status information, and a notification module configured to regularly notify a management apparatus of the use status information.

A management apparatus according to an embodiment, which is connected in a communicable manner with an order reception apparatus set forth in any one of claims 1˜5, comprises a reception module configured to receive the use status information serving as the history of the operation input and the image display in the operation device from the order reception apparatus, a determination module configured to determine whether or not a parameter of a use status is greater than a threshold value based on the use status information, and an alert notification module configured to execute an alert notification if the parameter of the use status is greater than the threshold value.

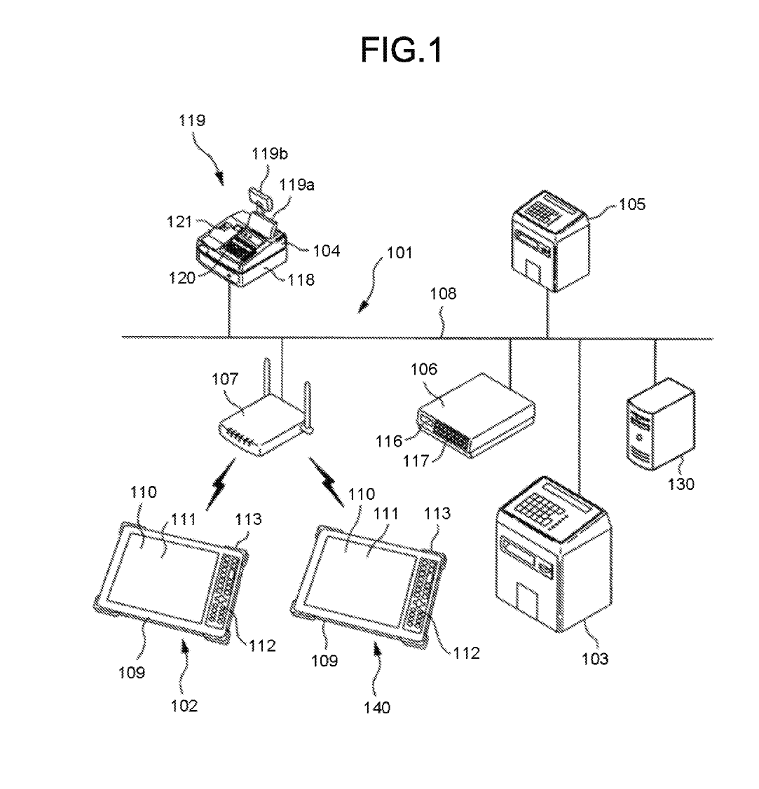

FIG. 1 is a system configuration diagram schematically illustrating the whole configuration of an order entry system 101 according to an embodiment. The order entry system 101 of the present embodiment is introduced into, for example, a tavern such as a bar.

As shown in FIG. 1, the order entry system 101 includes a plurality of order reception apparatuses 102, a kitchen printer 103, a POS terminal 104, a customer check printer 105, an order station 106, a management terminal 140, and an analysis server 130.

The order reception apparatus 102 that is handed over to a customer to be used is a self-ordering terminal through which the customer can order by himself/herself.

The kitchen printer 103 is arranged in a kitchen. The POS terminal 104 is arranged on a checkout counter. The customer check printer 105 is arranged in a dining hall.

The order station 106, arranged in a back office of a restaurant, functions as a management apparatus for controlling the whole of the order entry system 101. The order station 106 manages the order information of the customer and a use status of the order reception apparatus 102.

The management terminal 140 which has the same basic structure as the order reception apparatus 102 is a terminal that is handed over to a wait-staff to be used. The management terminal 140 receives the alert notification corresponding to the use status of the order reception apparatus 102 from the order station 106 to display it and is capable of executing an instruction operation to the order reception apparatus 102.

The analysis server 130 acquires the use status of the order reception apparatus 102 from the order station 106. The analysis server 130 is capable of analyzing and browsing purchase (order) characteristics from the acquired use status of the order reception apparatus 102.

The analysis server 130, the management terminal 140, the order reception apparatus 102, the kitchen printer 103, the POS terminal 104 and the customer check printer 105 are connected in a communication manner with the order station 106 via an LAN cable 108.

The POS terminal 104 is arranged on a drawer 118 which stores coins and bills in a freely taking-in/out manner. The POS terminal 104 includes a display for operator 119a, a display for customer 119b, an input device 120 including a keyboard and a mode key and a receipt printer 121.

The order reception apparatus 102 wirelessly communicates with the order station 106 via a radio repeater 107 arranged on a ceiling of the dining hall. The order reception apparatus 102 can input a table code for specifying a table, a menu code for specifying a menu item and a quantity of the menu item. The order reception apparatus 102 generates order information in which the menu code and the quantity of the menu item are associated with the table code.

The order information generated by the order reception apparatus 102 is sent to the order station 106 via the wireless communication. Then, the order information generated by the order reception apparatus 102 is sent to the kitchen printer 103, the POS terminal 104, the customer check printer 105 from the order station 106. The kitchen printer 103 and the customer check printer 105 issue slips on which contents corresponding to the received order information are respectively printed. The slip printed and issued by the kitchen printer 103 refers to a cooking instruction slip for instructing a cook in the kitchen cooking of the ordered menu items. The slip printed and issued by the customer check printer 105 refers to a slip to be delivered to a visitor (customer) after the ordered items or dishes are served. The kitchen printer 103 and the customer check printer 105 have the same basic structure. The POS terminal 104 executes a sales data processing containing a checkout processing based on the order information of the customer.

The management terminal 140 wirelessly communicates with the order station 106 via the radio repeater 107 arranged on the ceiling of the dining hall. The management terminal 140 generates or receives data relating to the management to display the data.

The hardware structures of the order reception apparatus 102 and the management terminal 140 are described. The order reception apparatus 102 and the management terminal 140 have the same basic structure. The order reception apparatus 102 and the management terminal 140 each have a thick plate-shaped main body housing 109. An LCD 111 serving as a display section to which a touch panel 110 (operation device) is added is arranged on one of the surface sides of the main body housing 109. A keyboard 112 as a user interface is arranged at the right side of the LCD 111 in FIG. 1. The LCD 111 functions as the display section to display information for a customer who uses the order reception apparatus 102 or for a wait-staff who uses the management terminal 140. The touch panel 110 detects a touch operation on an image displayed on the LCD 111 and outputs an input signal indicating content of the operation executed through the contact to a later-described touch panel controller 206. The keyboard 112 including numeric keys and a cross key constitutes the operation device together with the touch panel 110. Corner bumpers 113 each of which is an impact resistant member are mounted at four corners of the main body housing 109. Through the corner bumpers 113, the drop resistance performance of each of the order reception apparatus 102 and the management terminal 140 can be improved.

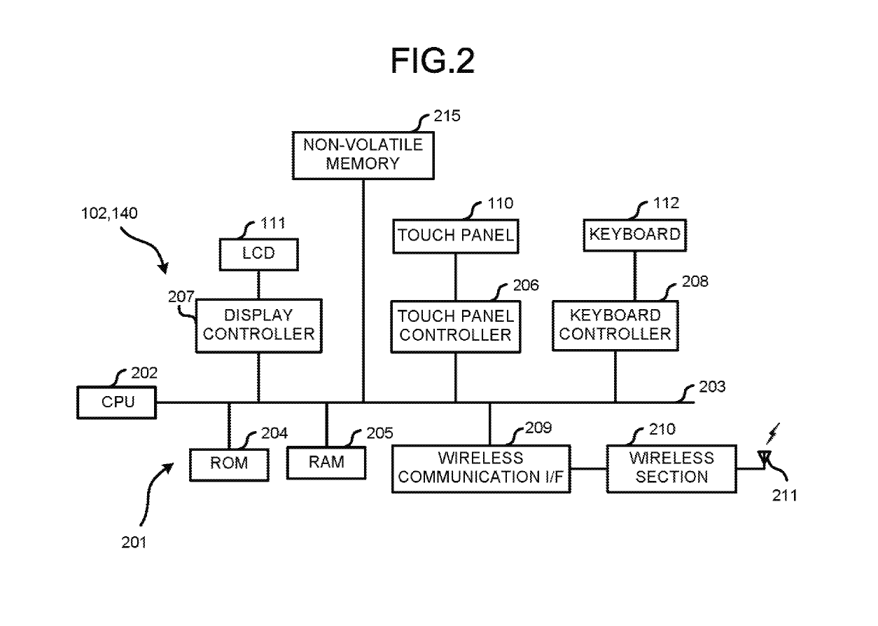

FIG. 2 is a block diagram illustrating the electrical connection of the order reception apparatus 102 and the management terminal 140. As shown in FIG. 2, the order reception apparatus 102 and the management terminal 140 each have a microcomputer 201 for controlling each section thereof. The microcomputer 201 is equipped with a CPU 202 (micro-processor), a ROM 204 for storing fixed information such as a control program in advance, a RAM 205 which stores various data in a rewritable manner and functions as a work area and a non-volatile memory 215 which stores data in a rewritable manner and can maintain the stored data without being supplied with power, via a bus line 203.

The microcomputer 201 is connected with, via the bus line 203, a touch panel controller 206, a display controller 207, a keyboard controller 208, a wireless communication interface 209 and a wireless section 210.

The touch panel controller 206 fetches the input signal from the touch panel 110 to the microcomputer 201. The display controller 207 drives and controls the LCD 111 based on an image data to enable the LCD 111 to display images corresponding to the image data. The keyboard controller 208 fetches the input signal from the keyboard 112 to the microcomputer 201.

The wireless communication interface 209 drives and controls the wireless section 210. The wireless section 210 executes a wireless communication with the radio repeater 107 via an antenna 211.

Various kinds of information such as the order information and the like input to the order reception apparatus 102 are sent to the radio repeater 107 from the wireless section 210. In this case, the destination of the order information is set to the order station 106. Thus, in a case in which the input information is the order information, the order information is wirelessly sent towards the order station 106. A function of inputting the order information through operations of the operation device such as the touch panel 110 or the keyboard 112 and a function of wirelessly sending the input order information to the order station 106 are realized.

For example, various kinds of information output from the order station 106 to the management terminal 140 are received by the wireless section 210 via the radio repeater 107.

The non-volatile memory 215 stores various data.

The management terminal 140 stores, for example, a basic OS and programs for various processing in the management terminal 140. All or a part of the programs and the basic OS are copied on the RAM 205 at the time the management terminal 140 is started. The microcomputer 201 of the management terminal 140 executes various processing according to the basic OS and the programs.

The order reception apparatus 102 stores, for example, a basic OS and programs for various processing in the order reception apparatus 102 and content data. The content data includes commodity information such as a menu picture, a menu item name, a unit price, a weight or quantity (volume) and a calorie in association with the menu code. Further, the content data also includes a category picture, a category name and the like. Further, the content data also includes data relating to various GUIs (Graphical User Interface). All or a part of the content data, the programs and the basic OS are copied on the RAM 205 at the time the order reception apparatus 102 is started. The microcomputer 201 of the order reception apparatus 102 executes various processing according to the basic OS and the programs.

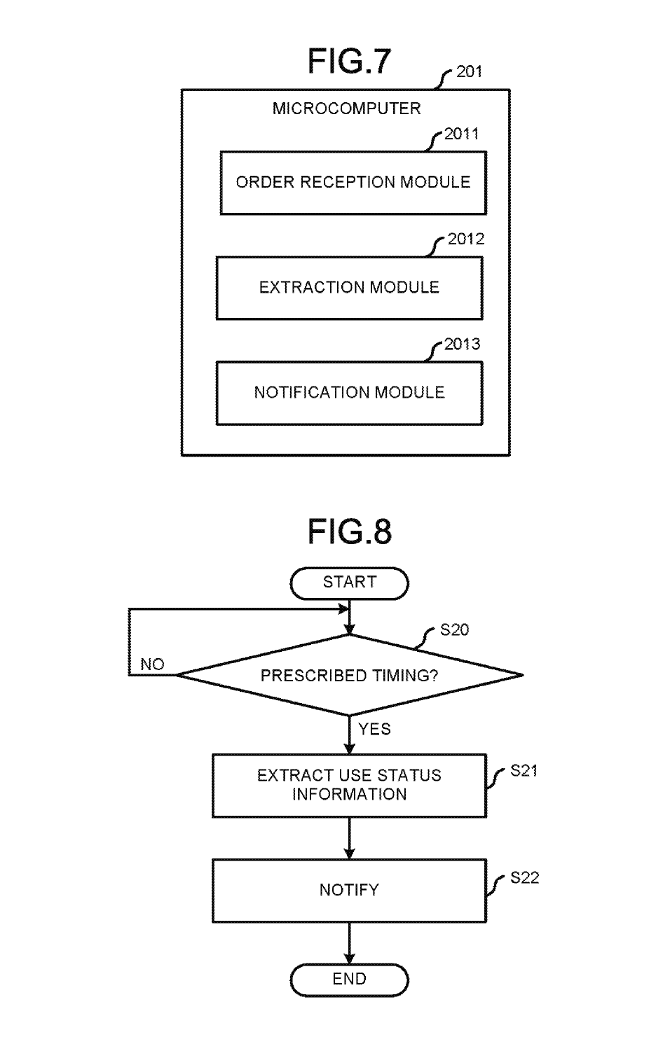

Within the various processing executed according to the basic OS and the programs by the microcomputer 201 of the order reception apparatus 102, an order reception processing by a later-described order reception module 2011 (refer to FIG. 7) is roughly described.

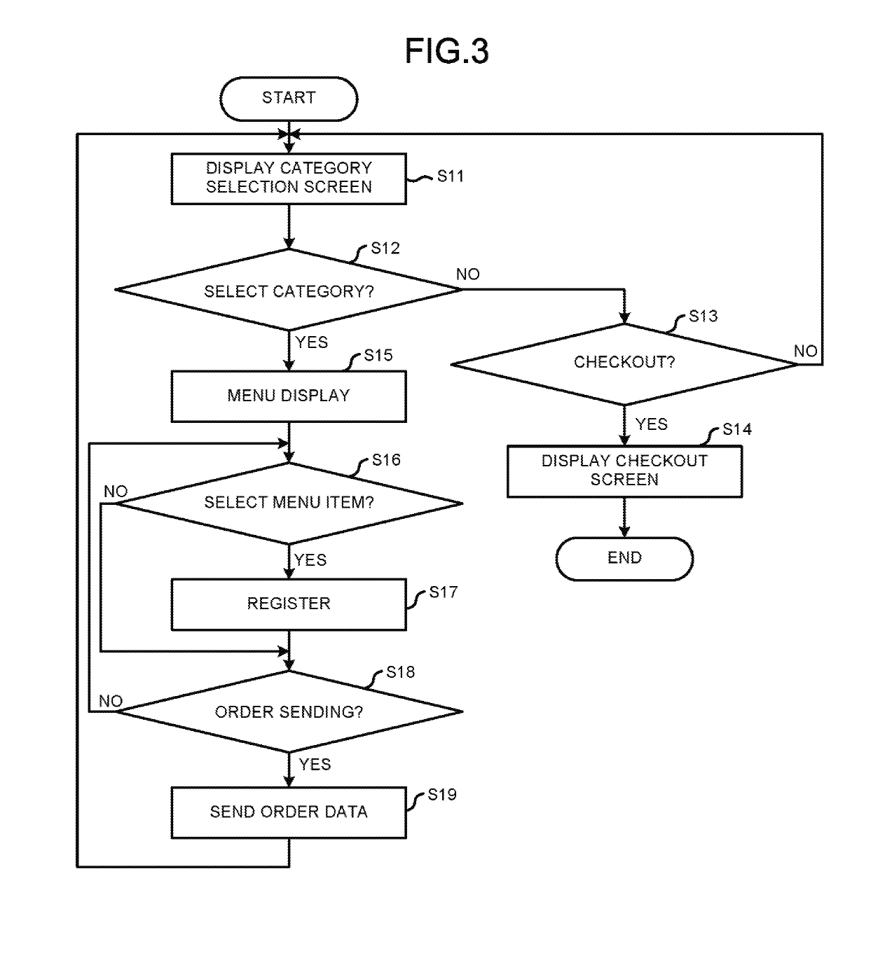

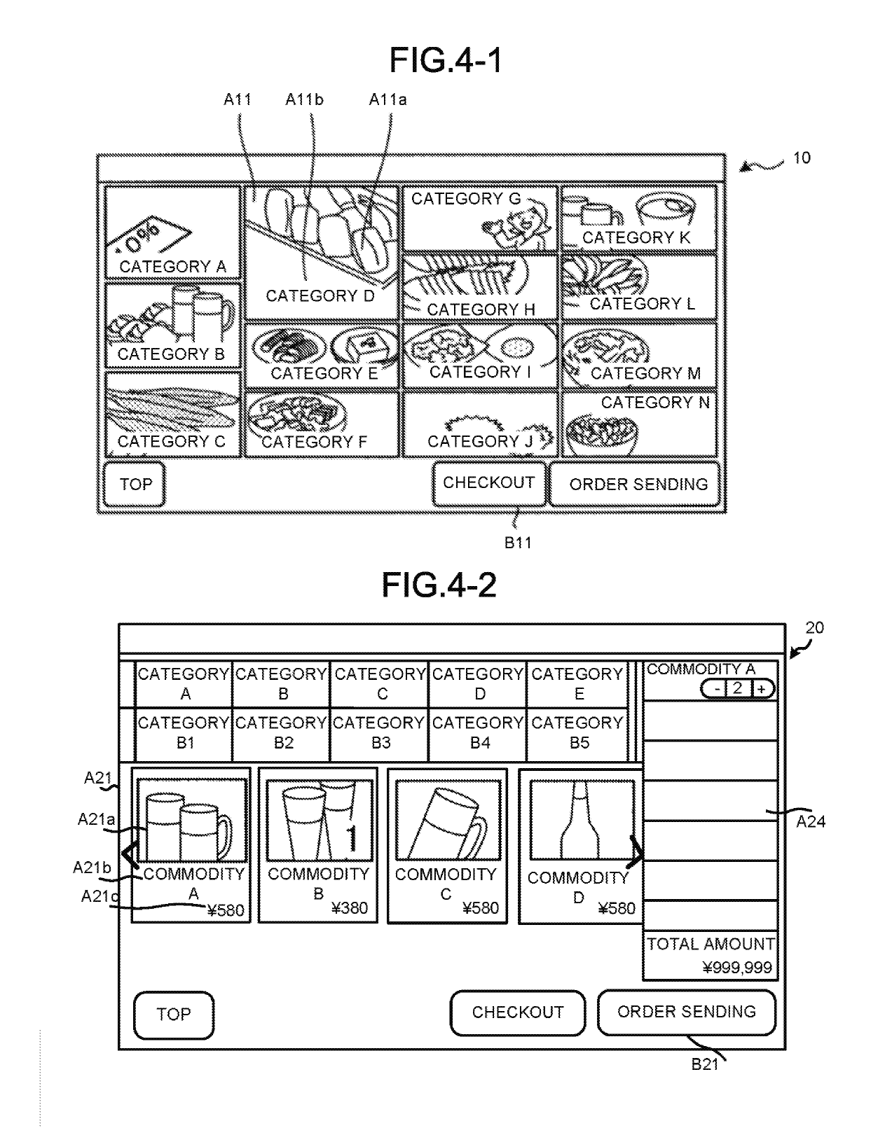

FIG. 3 is a flowchart illustrating an example of the flow of the order reception processing by the order reception apparatus 102. FIGS. 4 (FIG. 4-1 and FIG. 4-2) are a front view illustrating example of the screen display in the order reception processing on the LCD 111 of the order reception apparatus 102. Based on the flowchart in FIG. 3 and the example of the screen display in FIG. 4, an example of the order reception processing is described.

As shown in FIG. 3, the microcomputer 201 of the order reception apparatus 102 accesses the non-volatile memory 215 to acquire the content data stored in the non-volatile memory 215. Then, the microcomputer 201 of the order reception apparatus 102 enables the LCD 111 to display a category selection screen 10 based on the acquired content data (Act S11). In this way, the category selection screen 10 is displayed on the LCD 111 (refer to FIG. 4-1).

As shown in FIG. 4-1, the category selection screen 10 contains a category selection display A11 indicating each category of the menu items (sales targets). The category selection display A11 contains a category picture A11a and a category name A11b of each category.

As shown in FIG. 4-1, a checkout button B11 is displayed on the category selection screen 10. The checkout button B11 is designated by touching the touch panel 110 at the time the customer finishes eating and performs a check.

As shown in FIG. 3, the microcomputer 201 of the order reception apparatus 102 waits for until the checkout button B11 or the category selection display A11 is operated (No in Act S12→No in Act S13). If the checkout button B11 is pressed (No in Act S12→Yes in Act S13), the microcomputer 201 of the order reception apparatus 102 enables the LCD 111 to display a checkout screen (not shown) (Act S14) and terminates the present processing.

On the other hand, if the press operation on one of the category selection display A11 is received (Yes in Act S12), the microcomputer 201 of the order reception apparatus 102 displays the menu of the category on which the press operation is executed (Act S15). The microcomputer 201 of the order reception apparatus 102 executes a processing of displaying a menu selection screen 20 (second selection screen) on the LCD 111 based on the content data already acquired. In this way, the menu selection screen 20 is displayed on the LCD 111 (refer to FIG. 4-2).

As shown in FIG. 4-2, the menu selection screen 20 contains a menu selection display A21.

The menu selection display A21 is a first display area containing a menu picture A21a, a menu item name A21b and a unit price A21c for each menu item of one group including in a prescribed category. Menu codes are respectively associated with each menu selection display A21.

On the menu selection screen 20 shown in FIG. 4-2, a desired menu item can be selected for the purpose of ordering. In other words, the selection of the desired menu item is executed by touching the menu picture A21a of the desired menu item displayed on the menu selection display A21 of the menu selection screen 20.

As shown in FIG. 3, the microcomputer 201 of the order reception apparatus 102 waits for until a selection of the menu item or an instruction of sending the order is performed (No in Act S16→No in Act S18). If the customer selects the desired menu item for the purpose of the order (Yes in Act S16), the microcomputer 201 of the order reception apparatus 102 registers the menu code of the selected menu item and the quantity of the menu item, which are associated with each other as a set of one order content, in the work area of the RAM 205 (Act S17). The microcomputer 201 of the order reception apparatus 102 displays in a list format the order contents of which the transmission of the order is not completed among the order contents registered up to now in an order confirmation list A24.

The microcomputer 201 of the order reception apparatus 102 determines presence of the order transmission (Act S18), and if the event of the order transmission does not occur (No in Act S18), the microcomputer 201 returns to the processing in Act S16. In this way, the customer can continuously select the desired menu item on the menu selection display A21 of the menu selection screen 20 by touching the touch panel 110.

In Act S18, if the press operation on an order sending button B21 (refer to FIG. 4-2) is received (Yes in Act S18), the microcomputer 201 of the order reception apparatus 102 generates the order content (menu code and quantity of ordered item) of which the order transmission is not completed and the order information containing the table code and the number of people which are already registered. Then, the microcomputer 201 drives the wireless section 210 to wirelessly send the order information (Act S19), and returns to the processing in Act S11.

The order information wirelessly sent by the order reception apparatus 102 is received by the radio repeater 107. The radio repeater 107 outputs the order information to the LAN cable 108. Thus, the order station 106 serving as the sending destination contained in the order information receives the order information.

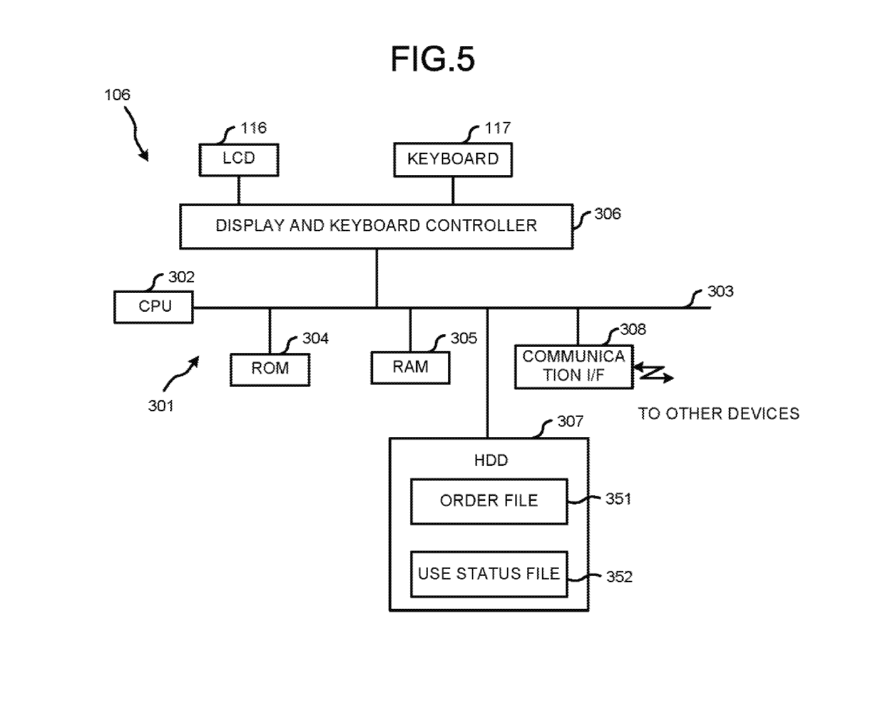

The electrical connection of the order station 106 is briefly described. FIG. 5 is a block diagram illustrating the electrical connection of the order station 106. As shown in FIG. 5, the order station 106 is equipped with a microcomputer 301 for controlling each section thereof. The microcomputer 301 includes a CPU 302 (microprocessor), a ROM 304 for storing fixed information such as control programs in advance, a RAM 305 which stores various data in a rewritable manner and functions as a work area, via a bus line 303. The microcomputer 301 constitutes an information processing section for executing an information processing. All or a part of the RAM 305 is a non-volatile memory.

The microcomputer 301 is connected with a display and keyboard controller 306, an HDD 307 and a communication interface 308 via the bus line 303.

The display and keyboard controller 306 controls an LCD 116 based on the image data to display images corresponding to the image data on the LCD 116, and further fetches the input signal from the keyboard 117 in the microcomputer 301. The communication interface 308 can execute a data communication with other devices, i.e., the analysis server 130, the kitchen printer 103, the POS terminal 104, the customer check printer 105 and the radio repeater 107 via the LAN cable 108.

The HDD 307 stores an order file 351 for storing the order information wirelessly sent from the order reception apparatus 102.

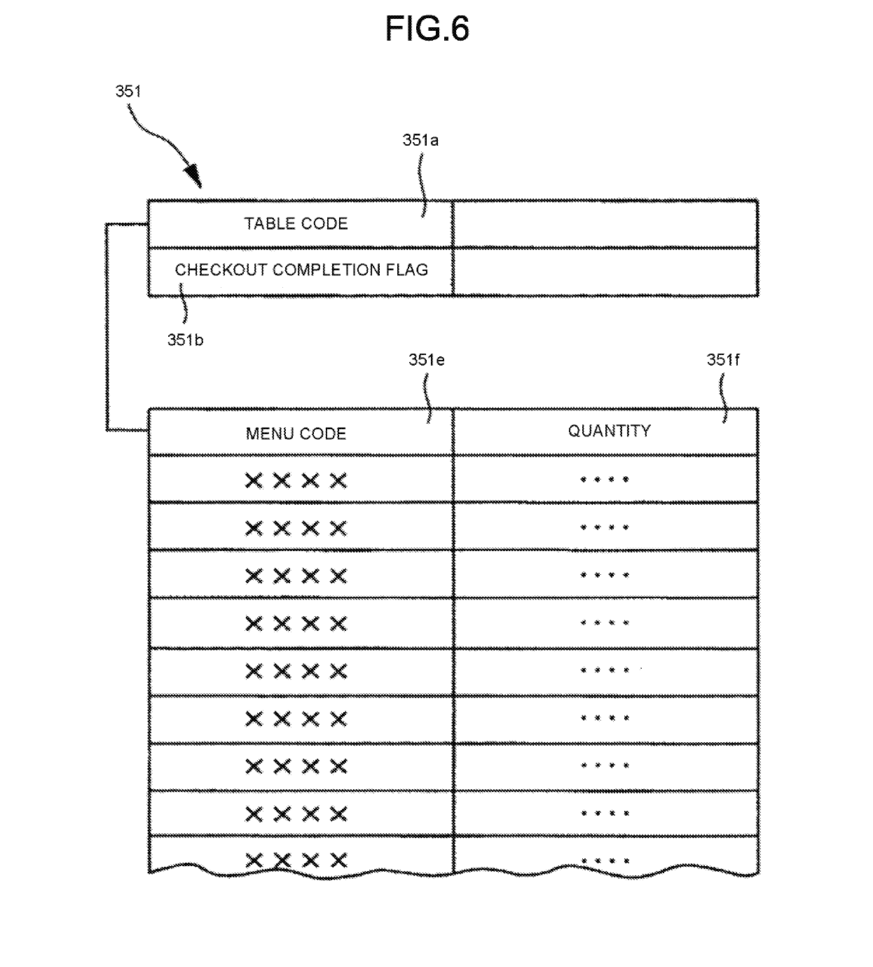

FIG. 6 is a schematic view illustrating an example of the data structure of the order file 351 stored in the order station 106. The order station 106 registers order information in the order file 351 if the order information from the order reception apparatus 102 is received.

The order file 351 includes a data structure capable of storing a checkout completion flag 351b and a table code 351a associated with each other. Further, the order file 351 includes a data structure capable of registering a menu code 351e and a quantity 351f thereof (quantity of item indicated by menu code) contained in the order information received from the order reception apparatus 102 in association with the table code 351a.

The HDD 307 stores a use status file 352 storing a parameter of the use status of the order reception apparatus 102. The followings are exemplified as the parameter of the use status stored in the use status file 352.

1. Touch operation information to the touch panel 110 of the order reception apparatus 102 (time and coordinate relating to the operation input to the image display of the LCD 111 and transition information of the operation input and the image display (e.g., a button) of the LCD 111 linked with the operation input)

2. Menu browsing information (whether or not the menu selection screen 20 serving as one of the image display for receiving the order information is displayed)

3. Menu selection information (whether or not the menu item is selected on the menu selection screen 20 serving as one of the image display for receiving the order information)

Next, a use status notification processing in various processing executed by the microcomputer 201 of the order reception apparatus 102 according to the basic OS and the programs is described.

FIG. 7 is a block diagram illustrating functions relating to the use status notification processing realized by the microcomputer 201 of the order reception apparatus 102, and FIG. 8 is a flowchart illustrating an example of the flow of the use status notification processing by the order reception apparatus 102.

As shown in FIG. 7, the microcomputer 201 of the order reception apparatus 102 operates according to the basic OS and the programs to function as an order reception module 2011, an extraction module 2012 and a notification module 2013.

The order reception module 2011 receives the order information relating to an order via the operation device such as the touch panel 110 and the keyboard 112.

The extraction module 2012 extracts the history of the operation input and the image display in the operation device such as the touch panel 110 and the keyboard 112 as the use status information.

The notification module 2013 regularly notifies the order station 106 serving as the management apparatus of the use status information.

As shown in FIG. 8, the microcomputer 201 (extraction module 2012) of the order receiving apparatus 102 extracts the use status information (Act S21) if a prescribed timing comes (Yes in Act S20). The prescribed timing refers to, for example, one minute. The followings are exemplified as the use status information.

1. Touch operation information to the touch panel 110 of the order reception apparatus 102 (time and coordinate relating to the operation input to the image display of the LCD 111 and transition information of the operation input and the image display (e.g., a button) of the LCD 111 linked with the operation input)

2. Menu browsing information (whether or not the menu selection screen 20 serving as one of the image display for receiving the order information is displayed)

3. Menu selection information (whether or not the menu item is selected on the menu selection screen 20 serving as one of the image display for receiving the order information)

Then, as shown in FIG. 8, the microcomputer 201 (notification module 2013) of the order reception apparatus 102 notifies the order station 106 of the use status information extracted in Act S21 (Act S22).

The microcomputer 201 of the order reception apparatus 102 regularly notifies the order station 106 of the extracted use status information (e.g., once a minute).

Next, an alert notification processing in various processing executed by the microcomputer 301 of the order station 106 according to a program is described.

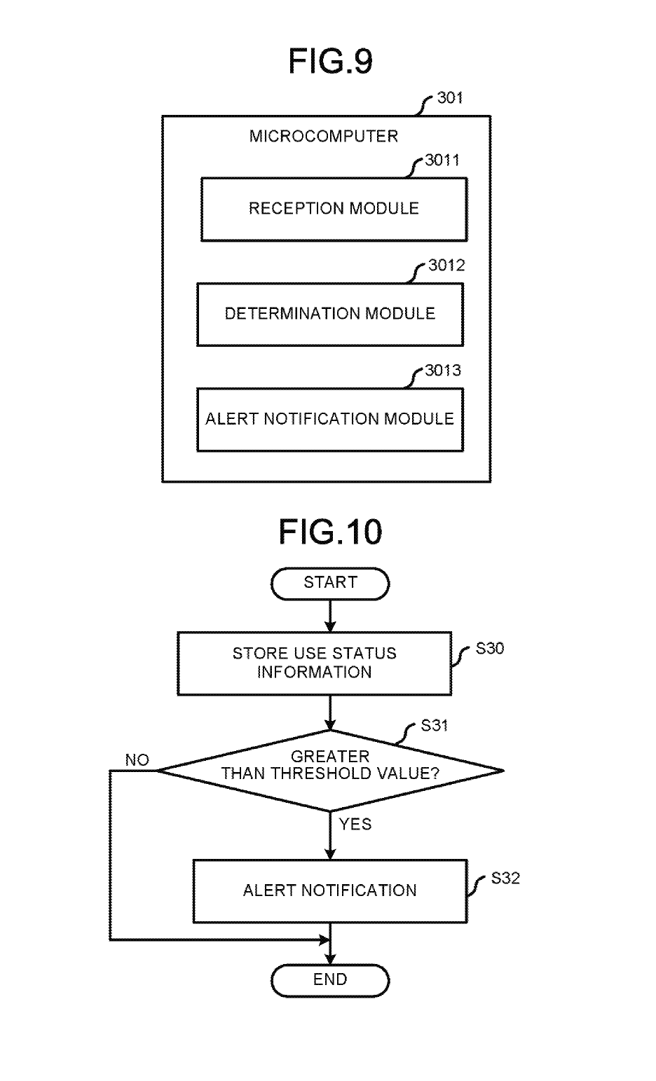

FIG. 9 is a block diagram illustrating functions relating to the alert notification processing realized by the microcomputer 301 of the order station 106, and FIG. 10 is a flowchart illustrating an example of the flow of the alert notification processing by the order station 106.

As shown in FIG. 9, the microcomputer 301 of the order station 106 operates according to the program to function as a reception module 3011, a determination module 3012 and an alert notification module 3013.

The reception module 3011 receives the use status information serving as the history of the operation input and the image display in the operation device such as the touch panel 110 and the keyboard 112 from the order receiving apparatus 102.

The determination module 3012 determines whether or not the parameter of the use status is greater than a threshold value based on the use status information.

The alert notification module 3013 executes the alert notification if the parameter of the use status is greater than the threshold value.

As shown in FIG. 10, the microcomputer 301 of the order station 106 stores the use status information regularly notified from the order reception apparatus 102 (Act S30).

Next, the microcomputer 301 (determination module 3012) of the order station 106 determines whether or not the parameter of the use status is greater than a certain threshold value (Act S31) based on the use status information regularly notified from the order reception apparatus 102.

The microcomputer 301 (alert notification module 3013) of the order station 106 executes the alert notification to the management terminal 140 (Act S32) if the parameter of the use status is greater than the certain threshold value (Yes in Act S31).

Examples of the use status and the alert notification based on the use status information are described.

1. Use status: No touch operation is performed on the touch panel 110 of the order reception apparatus 102 even if a certain time elapses after a customer enters the restaurant.

Alert notification: “Customer at ∘∘ table may not know how to use the order reception apparatus. Need to confirm.”

2. Use status: Touch operation is continuously executed on the touch panel 110 for a certain period of time although there is no transition of the image display of the LCD 111 linked with the touch operation on the touch panel 110 of the order reception apparatus 102 (a position irrelevant to the screen operation is continuously pressed).

Alert notification: “Trick is possibly played. Need to confirm.”

On the other hand, the microcomputer 201 of the management terminal 140 displays the alert notification received from the order station 106 on the LCD 111.

In addition, the microcomputer 301 of the order station 106 regularly (e.g., once a day) notifies the analysis server 130 of the use status information regularly notified from the order reception apparatus 102.

The analysis server 130 executes various data analysis processing based on the use status information regularly notified from the order station 106.

Examples of the data analysis processing in the analysis server 130 are described.

1. A menu to which the browsing is much but the registration (order) is little

[symbol] A written description with which the order is promoted is added.

2. A menu which is supposed to be popular but the browsing of which is little

[symbol] The menu is rearranged at a position on the screen at which the menu is easily found.

A shop staff such as the wait-staff can review setting and operation method of the self-ordering on the basis of the result of the data analysis processing in the analysis server 130.

According to the present embodiment, the use state of the order reception apparatus 102 of the order entry system 101 (e.g., the image display (for example, a button) of the LCD 111 is frequently and carelessly touched, non-operation time is long after the order is performed, order is not made once after the customer enters the restaurant, a menu ordered in an order reception operation by the wait-staff is not ordered in the self-ordering operation, and the like) is collected.

With the analysis of such collected use state, if there is a customer who plays a trick or does not know the operation of the order reception apparatus, the alert notification is sent to the management terminal 140 of the wait-staff to facilitate the solution in real time. The customer who uses the order reception apparatus 102 can use the order reception apparatus 102 without the burden even for the first time through the support of the wait-staff who receives the alert notification.

Further, if the layout of the menu display of the order reception apparatus 102 is improper, there is a case in which the sales promotion cannot be realized for the reason that the customer who operates the order reception apparatus 102 cannot access to or reach the menu serving as the target of the sales promotion. For this point, as it can be determined as a chance to change the menu display position or modify the menu itself for the menu that is rarely ordered, the sales promotion can be efficiently performed by the wait-staff through the self-ordering.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

In the foregoing embodiment, the order reception apparatus 102 notifies the order station 106 of the extracted use status information; however, it is not limited to this. For example, the order reception apparatus 102 notifies the order station 106 of the extracted use status information, and meanwhile may also notify the management terminal 140 of the extracted use status information. In this case, the management terminal 140 functions as the management apparatus. In other words, the microcomputer 201 of the management terminal 140 operates according to the basic OS and the programs to function as the reception module 3011, the determination module 3012 and the alert notification module 3013.

The basic OS and the programs executed by the order reception apparatus 102 and the management terminal 140 of the foregoing embodiment may be recorded in a computer-readable recording medium such as a CD-ROM, an FD (Flexible Disk), a CD-R, a DVD (Digital Versatile Disk) and the like in a form of an installable or executable file to be provided.

The basic OS and the programs executed by the order reception apparatus 102 and the management terminal 140 of the foregoing embodiment may be stored in a computer connected with a network such as an internet and downloaded through the network to be provided. The basic OS and the programs executed by the order reception apparatus 102 and the management terminal 140 of the foregoing embodiment may be provided or distributed via the network such as the internet.

The program executed by the order station 106 of the foregoing embodiment may be may be recorded in a computer-readable recording medium such as a CD-ROM, an FD (Flexible Disk), a CD-R, a DVD (Digital Versatile Disk) and the like in a form of an installable or executable file to be provided.

The program executed by the order station 106 of the embodiment may be stored in a computer connected with a network such as an internet and downloaded through the network to be provided or may be provided or distributed via the network such as the internet.

What is claimed is:

1. An order reception apparatus, comprising:
an operation device configured to receive an image display and an operation input;
an order reception module configured to receive an order information relating to an order via the operation device;
an extraction module configured to extract a history of the operation input and the image display in the operation device as a use status information; and
a notification module configured to regularly notify a management apparatus of the use status information.

2. The order reception apparatus according to claim 1, wherein the use status information refers to a time and a coordinate relating to the operation input to the image display of the operation device.

3. The order receiving apparatus according to claim 1, wherein the use status information refers to a transition information of the operation input and the image display linked with the operation input to the operation device.

4. The order reception apparatus according to claim 1, wherein the use status information refers to the screen information, serving as one of the image display of the operation device, for receiving the order information.

5. The order reception apparatus according to claim 1, wherein the use status information refers to the operation input with respect to the screen information, serving as one of the image display of the operation device, for receiving the order information.

6. A management apparatus which is connected in a communicable manner with an order reception apparatus set forth in claim 1, comprising:
a reception module configured to receive the use status information serving as the history of the operation input and the image display in the operation device from the order reception apparatus;
a determination module configured to determine whether or not a parameter of a use status is greater than a threshold value based on the use status information; and
an alert notification module configured to execute an alert notification if the parameter of the use status is greater than the threshold value.

7. The order reception apparatus according to claim 6, wherein the use status information refers to a time and a coordinate relating to the operation input to the image display of the operation device.

8. The order receiving apparatus according to claim 6, wherein the use status information refers to a transition information of the operation input and the image display linked with the operation input to the operation device.

9. The order reception apparatus according to claim 6, wherein the use status information refers to the screen information, serving as one of the image display of the operation device, for receiving the order information.

10. The order reception apparatus according to claim 6, wherein the use status information refers to the operation input with respect to the screen information, serving as one of the image display of the operation device, for receiving the order information.
